(19) United States
(12) Patent Application Publication
(10) Pub. No.: US 2025/0363696 A1
(43) Pub. Date: Nov. 27, 2025

(54) HIGHLIGHTING TARGET ITEMS IN IMAGES CAPTURED BY SMART CARTS

(71) Applicant: Maplebear Inc., San Francisco, CA (US)

(72) Inventors: David McIntosh, San Francisco, CA (US); Dominic Cocchiarella, Berkeley, CA (US); Anirban Kundu, Danville, CA (US)

(21) Appl. No.: 19/217,924

(22) Filed: May 23, 2025

Related U.S. Application Data
(60) Provisional application No. 63/651,314, filed on May 23, 2024.
(60) Provisional application No. 63/651,836, filed on May 24, 2024.

(51) Int. Cl. G06T 11/60; G06Q 10/087; G06Q 30/0601; G06T 5/60; G06V 10/778; G06V 20/52; G06V 20/60

(52) U.S. Cl. CPC G06T 11/60; G06Q 10/087; G06Q 30/0633; G06Q 30/0639; G06T 5/60; G06V 10/7788; G06V 20/52; G06V 20/60; G06V 2201/07

(57) ABSTRACT

A system may store a plurality of images depicting items within an environment, where each image was captured by a camera coupled to a shopping cart. The system identifies a target item associated with a user device that is located within the environment. The system identifies a location of the target item within the environment based on item data associated with the target item and environment map data describing the environment. The system selects, from the plurality of images, an image depicting the item at the location within the environment based on the environment map data and the location data associated with each of the plurality of images. The system identifies a portion of the identified image that depicts the item by applying a machine-learning model to the identified image. The system modifies the identified portion of the identified image to highlight the target item.

### CROSS REFERENCE TO RELATED APPLICATIONS

This application claims the benefit of U.S. Provisional Patent Applications Nos. 63/651,314, filed May 23, 2024, and 63/651,836, filed May 24, 2024, each of which is incorporated by reference in its entirety.

### BACKGROUND

Traditional systems primarily utilize data collected from a single device to locate objects in an environment. For example, the system may interact with various devices in a specific setting, each gathering sensor data about the surrounding conditions, and use the sensor data and computer vision techniques to locate objects. However, this system limits its analysis to each device separately, only considering sensor data on a device-by-device basis. Traditionally, systems may have done so due to lack of network connectivity within an environment or the additional use of resources required at the devices. However, as network connectivity and efficient resource usage has improved at devices that capture sensor data (like mobile phones, smart shopping carts, etc.), the systems have not begun linking crowdsourced sensor data together to understand the environment(s) described by the sensor data. Thus, the system may be unable to determine the location of an object that a respective device has not captured image data of, despite the plethora of sensor data describing the environment that the system has access to.

In the context of image data, a device may use computer vision techniques to identify objects depicted in the image data. But many devices may only capture a limited amount of image data, based on where the device has been moved within an environment. Without capturing image data depicting an object, devices are incapable of recognizing and situating the specific object in its environment. More particularly, the devices may be limited in this way based on their inability to visually cross-reference an object with its stored image dataset when no related data exists. Therefore, the application of computer vision technology in these scenarios could lead to misinterpretations or incomplete assessments of an object's context.

### SUMMARY

In accordance with one or more aspects of the disclosure, a system may select an image from a plurality of images taken by smart shopping carts and modify the image to highlight an item a user is looking for within an environment. More particularly, the environment may include display screens that present content about one or more items to users. The display screens may each communicate with a smart shopping cart that traverses the environment with the user. A system that communicates with the smart shopping carts may determine that a user is searching for an item and identifies which item the user is searching for. The system identifies an image recently captured by a smart shopping cart that depicts where the item is located in the environment. When the user gets close to the location of the item, the system causes the display screen at the shopping cart to present the image, which may be modified to highlight the item.

In accordance with one or more embodiments, the system may store a plurality of images depicting items within an environment. Each image was captured by a camera coupled to a shopping cart in the environment and is associated with location data captured by a location sensor of the corresponding shopping cart. Each image was captured less than a threshold amount of time from a current time. The system identifies a target item associated with a user device that is located within the environment. The system identifies a location of the target item within the environment based on item data associated with the target item and environment map data describing the environment. The system selects, from the plurality of images, an image depicting the item at the location within the environment based on the environment map data and the location data associated with each of the plurality of images. The system identifies a portion of the identified image that depicts the item by applying a machine-learning model to the identified image. The machine-learning model is trained to identify portions of images that depict items. The system modifies the identified portion of the identified image to highlight the target item and transmits the image to the device for display to the user.

### BRIEF DESCRIPTION OF DRAWINGS

FIG. 1 illustrates an example environment of a smart cart system, in accordance with one or more illustrative embodiments.

FIG. 2 illustrates a block diagram of a remote system, in accordance with one or more illustrative embodiments.

FIG. 3A illustrates threshold areas within an item environment, in accordance with one or more illustrative embodiments.

FIG. 3B illustrates a camera of a shopping cart capturing an image of an item, in accordance with one or more illustrative embodiments.

FIG. 3C illustrates a shopping cart presenting an image of an item at an onboard display, in accordance with one or more illustrative embodiments.

FIG. 4 is a flowchart of a method for presenting an image of an identified item, in accordance with one or more illustrative embodiments.

### DETAILED DESCRIPTION

### Example System Environment for Smart Cart System

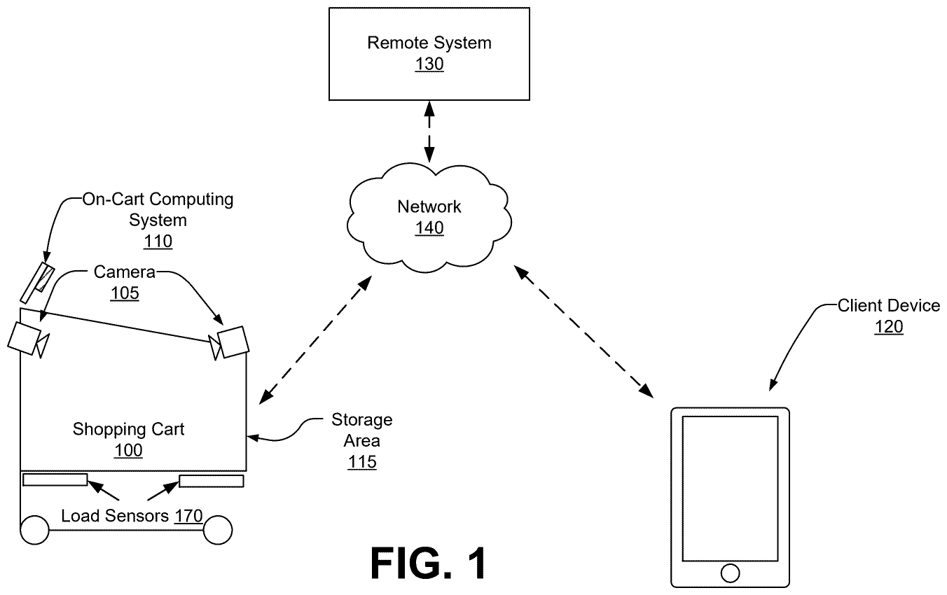

FIG. 1 illustrates an example system environment for a smart cart system, in accordance with one or more illustrative embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves—the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 apply a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and charge the user for the cost of the items in the cart. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

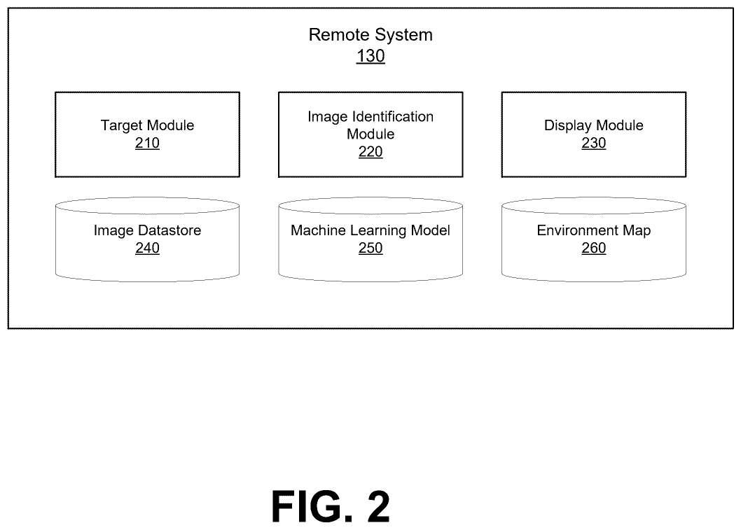

FIG. 2 illustrates a block diagram of the remote system 130, in accordance with one or more illustrative embodiments. The remote system 130 includes a target module 210, image identification module 220, display module 230, an image datastore 240, a machine-learning model 250, and an environment map 260. In some embodiments, the remote system 130 includes additional or alternative components to those shown in FIG. 2.

The target module 210 identifies target items for client devices 120. A target item is a next item to be collected by a user of a client device 120 in an environment. For example, the user may be looking for the target item to add to their shopping cart 100. The target module 210 accesses order data from a client device 120. In some embodiments, the target module 210 automatically accesses the order data from each client device 120 in the environment at set time intervals or in response to a request from an external operator or client device 120. The order data includes an ordered list of items stored at the client device 120. The order of the ordered list is indicative of an order for retrieving items in the list within the environment. The target module 210 may store the order data in local storage at the remote system 130 in association with an identifier of the client device 120.

The target module 210 determines which items in an ordered list have already been retrieved by a user associated with the client device 120. The target module 210 determines a shopping cart 100 associated with the client device 120. In some embodiments, the shopping cart 100 and client device 120 may be communicatively coupled, such that the target module 210 may access an identifier of the shopping cart 100 from the client device 120. In some embodiments, the target module 210 accesses sensor data from shopping carts 100 in the environment. Using the sensor data, the target module 210 may determine which shopping cart 100 is associated with the client device 120 based on a user account being logged in at both the client device 120 and the shopping cart 100, the client device 120 and shopping cart 100 being located within a threshold vicinity of one another for a threshold period of time, or only items from the ordered list being located within the shopping cart 100. The target module 210 may store an identifier of the shopping cart 100 in association with the identifier of client device 120 in local storage at the remote system 130.

The target module 210 determines which, if any, items in the ordered list associated with each client device 120 have been retrieved by the user. In particular, the target module 210 accesses sensor data from the shopping cart 100. The sensor data may include radio frequency identification (RFID) data, image data, and interaction data, each of which the target module 210 may use to determine what items are in the shopping cart 100. For instance, the target module 210 may access RFIDs or images of the items from local storage and compare the RFIDs or images to RFID data or image data accessed for the shopping cart. In another example, the target module 210 may access interaction data from the on-cart computing system 110 of the shopping cart 100 or the client device 120, where the interaction data includes indications of interactions with a touchscreen display of the on-cart computing system 110. The target module 210 determines whether the user interacted with an image or other identifier of one or more items (e.g., such as to check off the item as found). The target module 210 may track which items in the ordered list have retrieved in comparison to the ordered list for the client device 120, such as by creating a new ordered list in local storage that the target module 210 updates to remove items that have been identified in the shopping cart 100.

The target module 210 may determine the target item as the first item in the updated ordered list stored in association with the identifier of the client device 120. In some embodiments, the target module 210 determines the target item by requesting, from the client device 120, a set of content being presented at the client device 120 and identifies the target item in response to determining that the set of content describes the target item. The target module 210 stores an updated ordered list including the items that the user has not yet retrieved in the local storage of the remote system 130 in association with the identifier of the client device 120. The target module 210 sends the identifier of the target item to the image identification module 220.

The image identification module 220 identifies and modifies images depicting target items. The image identification module 220 may receive an identifier of a target item from the target module 210. The image identification module 220 determines a location of storage of the target item in the environment. For example, the target item may be located on a particular shelf in a particular aisle. In some embodiments, the image identification module 220 may access an environment map 260 that indicates the placements of items for storage within the environment. The image identification module 220 identifies the location of the target item based on its position within the environment map 260.

In some embodiments, the image identification module 220 identifies the location of the target item by inputting the identifier of the target item to the machine-learning model 250. The machine-learning model 250 may be trained on identifiers of items in the environment labeled with one or more images depicting a respective item, where the images captured by cameras 105 coupled to shopping carts 100 in the environment. The image identification module 220 receives a subset of the plurality of images depicting the target item from the machine-learning model 250. The image identification module 220 identifies a plurality of locations. Each of the plurality of locations is associated with one of the subset of images, and the image identification module 220 determines the locations of images based on location data captured by a respective camera 105 coupled to a respective shopping cart 100 that captured the respective image. The image identification module 220 identifies the location of the target item based on an aggregation of the plurality of locations—that is, the image identification module 220 may determine the location of the target item to be the average location of the plurality of locations, the location associated with the most images from the subset, and the like.

In some embodiments, the image identification module 220 updates the environment map 260 periodically or based on receiving an indication from an external operator. For instance, the image identification module 220 may access image data 240 from shopping carts 100 in the environment. Each image may be associated with a location of the shopping cart 100 within the environment when the image was captured. The image identification module 220 may analyze the images to determine whether the images depict one or more items at locations that do not correspond to the map. For example, the image identification module 220 may input the identifiers of the items to a machine-learning model 250 trained on identifiers of items in the environment labeled with one or more images depicting a respective item, where the images were captured by cameras 105 coupled to shopping carts 100 in the environment. The image identification module 220 may receive groups of images depicting an associated item. Each image may be associated with location data captured by the shopping cart 100 at the same time as the image, and the image identification module 220 compares the location of each image to a location of the item depicted as described in the environment map 260. The image identification module 220 may update the location of an item in the environment map 260 in response to determining that a threshold number of images in a group depict the item at a different location than the one described in the environment map 260.

The image identification module 220 selects an image from the image data 240 that includes the target item. In some embodiments, the image identification module 220 selects from image data captured within a threshold amount of time from a current time (e.g., images captured that day, week, etc.). The image identification module 220 may input the images to the machine-learning model 250, which is trained to identify portions of images that depict items. The image identification module 220 may input the identifier of the target item to the machine-learning model 250 and receive an input image that shows the target item. In some embodiments, the machine-learning model includes a box or highlight around the portion within the image itself. In some embodiments, the machine-learning model 250 may also output a second image that is the portion of the image that shows the target item, and the image identification module 220 modifies the image to highlight the target item in the portion. For instance, the image identification module 220 may outline the portion of the image within the image or place a border around the portion of the image to highlight the target item. The image identification module 220 may store the modified image in relation to the identifier of the target item in local storage and send the modified image to the display module 230.

The display module 230 accesses modified images from the image identification module 220. For a received modified image, the display module 230 may cause the client device 120 to present the modified image or may cause an on-cart computing system 110 of the shopping cart 100 to present the modified image. In some embodiments, the display module 230 causes the modified image to be displayed with one or more interactive elements configured to receive a rating of the image from the user. For instance, the user may interact with one or more of the interactive elements to indicate how useful the modified image was to find the target item. In some embodiments, the display module 230 accesses a location of the client device 120 or shopping cart 100 and accesses a threshold area associated with the target item in the environment map 260. The display module 230 may send the modified image to the client device 120 or shopping cart 100 in response to determining that the client device 120 or shopping cart 100 is within the threshold area of the location of the target item in the environment.

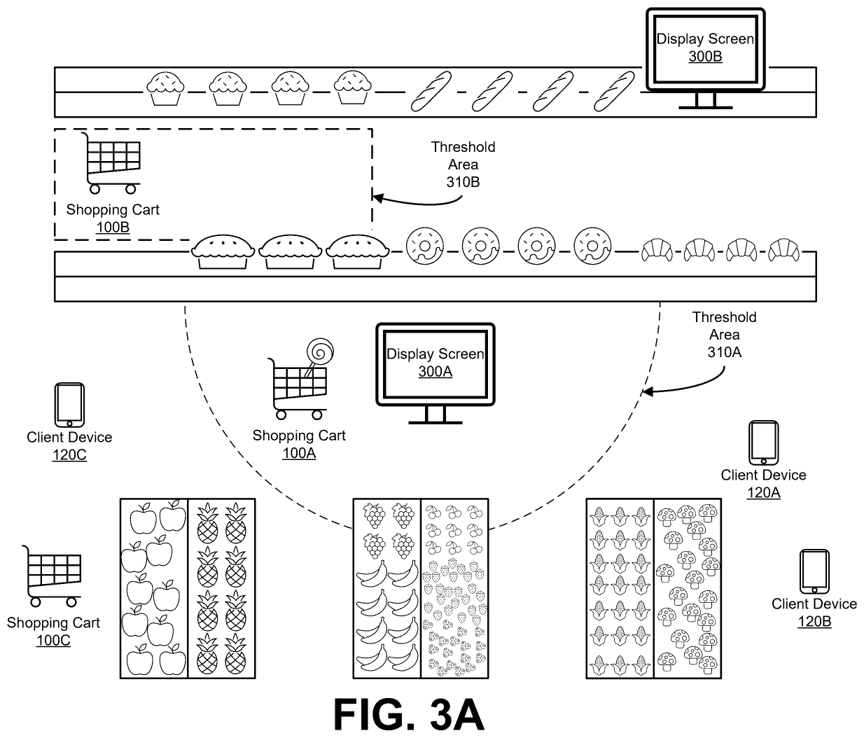

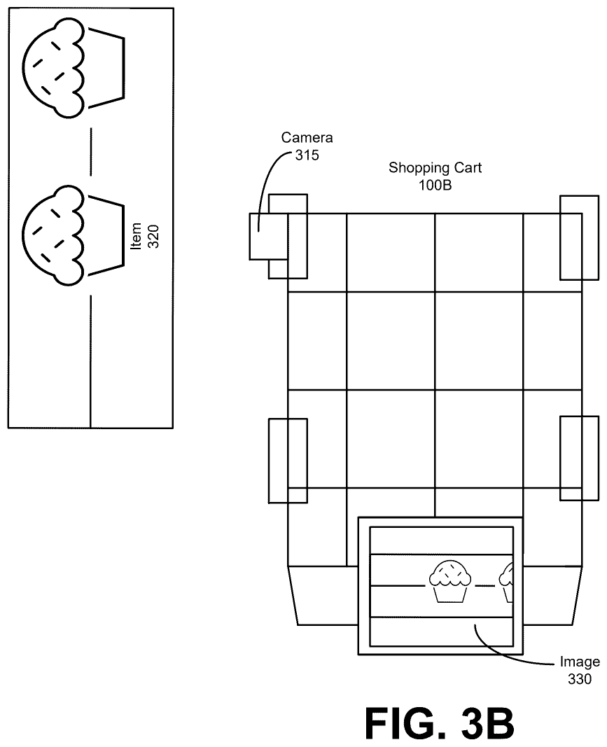

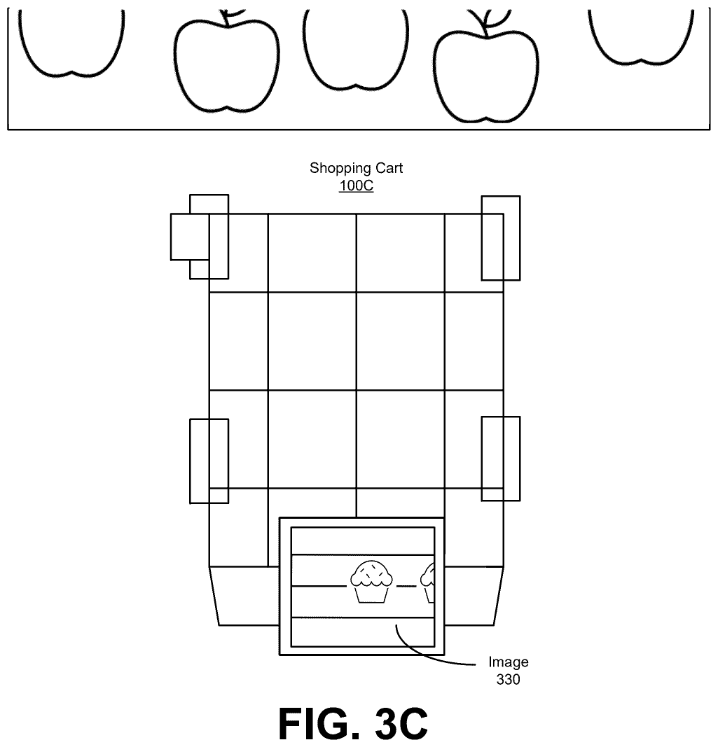

FIG. 3A illustrates threshold areas 310 within an environment 300 of items, in accordance with one or more illustrative embodiments. As shown in FIG. 3A, the threshold areas 310 associated with item locations may be of different sizes and shapes, which allows the threshold areas to be tailored (e.g., by an external operator) to the structure of the environment 300. For example, the threshold area around display screen 300A, which may be presenting content about a target item for shopping cart 100A, may extend equidistantly from the display screen for the area of the environment that is in front of the aisle shown in the environment 300. Thus, the display screen 300A or a client device 120 associated with the shopping cart 100A may present a modified image of the target item associated with shopping cart 100A in response to the shopping cart 100A being within the threshold area 310A. In another example, the threshold area 310B may be associated with pies and covers an area of the environment that is within the same aisle as pies. When the shopping cart 100B entered into the threshold area 310B associated with pie, while the shopping cart 100B is associated with the target item of pie, the shopping cart 100B may present a modified image of pie on the shelf shown in the environment. The image may have been captured recently (e.g., within a threshold amount of time from a current time) by another shopping cart 100 in the environment 300.

In another example shown in FIG. 3B, shopping cart 100B may use an onboard camera 315 to capture an image 330 of an item 320, which shopping cart 100B may present an onboard display. Shopping cart 100C is associated with the item 320 as its next item (e.g., the item 3209 its user is looking for). Shopping cart 100C may present the image 330 in response to determining that the item 320 is the next item, as is shown in FIG. 3C, or may display the image 330 once shopping cart 100C enters the aisle of the item 320 or threshold area 310B.

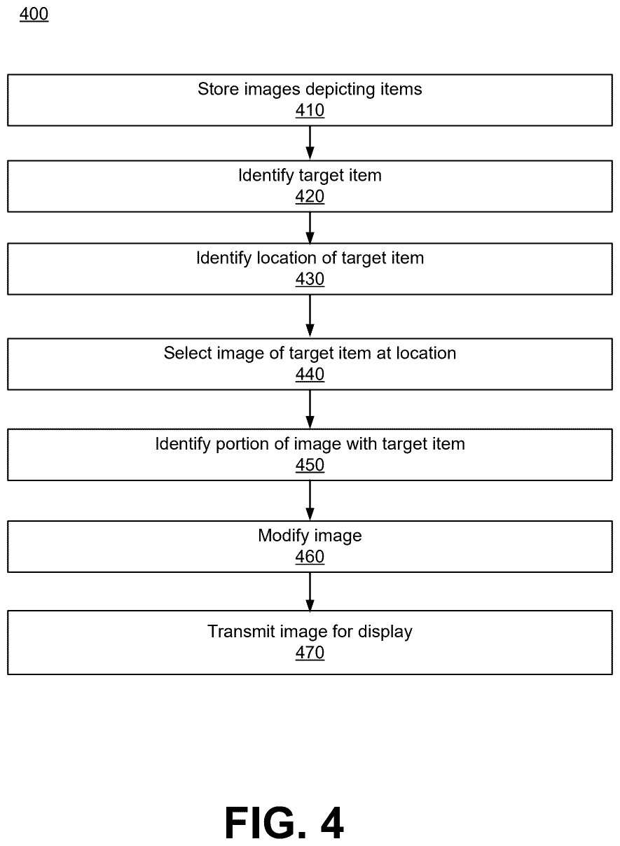

FIG. 4 is a flowchart of a method 400 for presenting an image of an identified item, in accordance with one or more illustrative embodiments. In some embodiments, the method 400 includes additional or alternative steps or uses additional or alternative components to those shown in FIG. 4.

The method 400 begins with the remote system 130 storing 410 a plurality of images depicting items within an environment. Each image may have been captured by a camera 105 coupled to a shopping cart 100 in the environment 300 and associated with location data captured by a location sensor of the corresponding shopping cart 100. Further, each image may have been captured less than a threshold amount of time from a current time. The target module 210 identifies 420 a target item associated with a client device 120, where the client device 120 is located within the environment 300 and may correspond to a shopping cart 100 within the environment 300. The image identification module 220 identifies 430 a location of the target item within the environment 300 based on item data associated with the target item and an environment map data describing the environment, including locations of items within the environment 300.

The image identification module 220 selects 440, from the plurality of images, an image depicting the target item at the location within the environment 300 based on the environment map 260 and the location data associated with each of the plurality of images. The image identification module 220 identifies 450 a portion of the identified image that depicts the target item by applying a machine-learning model 250 to the identified image. The machine-learning model 250 is trained to identify portions of images that depict items. The image identification module 220 modifies 460 the identified portion of the identified image to highlight the target item, and the display module 230 transmits 470 the image to the client device 120 for display to a user.

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising:
storing a plurality of images depicting items within an environment, each image captured by a camera coupled to a shopping cart in the environment and associated with location data captured by a location sensor of the corresponding shopping cart, wherein each image was captured less than a threshold amount of time from a current time;
identifying a target item associated with a user device, wherein the user device is located within the environment;
identifying a location of the target item within the environment based on item data associated with the target item and environment map data describing the environment;
selecting, from the plurality of images, an image depicting the item at the location within the environment based on the environment map data and the location data associated with each of the plurality of images;
identifying a portion of the identified image that depicts the target item by applying a machine-learning model to the identified image, wherein the machine-learning model is trained to identify portions of images that depict items;
modifying the identified portion of the identified image to highlight the target item; and
transmitting the image to the user device for display.

2. The method of claim 1, wherein the machine-learning model is trained on training images, a portion of each training image labeled with an item depicted in the portion of the training image, the method further comprising:
receiving, from the machine-learning model, the portion of the identified image.

3. The method of claim 2, wherein each image is further labeled with a rating of the image input by a user of the corresponding shopping cart via the device, the method further comprising:
causing the device to display one or more interactive elements configured to receive a rating of the image from the user.

4. The method of claim 3, further comprising:
training the machine-learning model on the image labeled with the rating from the user.

5. The method of claim 1, wherein identifying a location of the target item within the environment comprises:
inputting an identifier of the target item and the plurality of images to a machine-learning model, the machine-learning model trained on identifiers of items in the environment labeled with one or more images depicting a respective item, the images captured by cameras coupled to shopping carts in the environment;
receiving, from the machine-learning model, a subset of the plurality of images depicting the target item;
identifying a plurality of locations, wherein each of the plurality of locations is associated with one of the subset of images, each location determined based on location data captured by a respective camera coupled to a respective shopping cart that captured the respective image; and
identifying the location of the target item based on an aggregation of the plurality of locations.

6. The method of claim 1, wherein identifying the target item comprises identifying a next item to be collected by the user by:
receiving an ordered list of items stored at the device, wherein the order of the list is indicative of an order for retrieving items in the list within the environment;
identifying that one of more of the items in the list have been retrieved by the user based on sensor data; and
identifying a next item for retrieval based on the one or more of the items that have been retrieved and the order of the list, wherein the next item is the item.

7. The method of claim 6, wherein the sensor data includes one or more of an interaction with a touchscreen display, a radio frequency identification (RFID) detection associated with the item, or an image of the item in a shopping cart associated with the user.

8. The method of claim 1, wherein identifying the target item associated with the user device comprises:
requesting, from the device, content being presented at the device; and
identifying the target item in response to determining that the content describes the target item.

9. The method of claim 1, wherein transmitting the image to the device for display to the user is responsive to determining, based on location data received from the device, that the device is within a threshold area of the location in the environment.

10. The method of claim 1, wherein modifying the identified portion of the identified image to highlight the target item comprises adding a border around the identified portion in the identified image.

11. A non-transitory computer-readable storage medium storing instructions that, when executed, cause a processor to perform steps comprising:
storing a plurality of images depicting items within an environment, each image captured by a camera coupled to a shopping cart in the environment and associated with location data captured by a location sensor of the corresponding shopping cart, wherein each image was captured less than a threshold amount of time from a current time;
identifying a target item associated with a user device, wherein the user device is located within the environment;
identifying a location of the target item within the environment based on item data associated with the target item and environment map data describing the environment;
selecting, from the plurality of images, an image depicting the item at the location within the environment based on the environment map data and the location data associated with each of the plurality of images;
identifying a portion of the identified image that depicts the target item by applying a machine-learning model to the identified image, wherein the machine-learning model is trained to identify portions of images that depict items;
modifying the identified portion of the identified image to highlight the target item; and
transmitting the image to the user device for display.

12. The non-transitory computer-readable storage medium of claim 11, wherein the machine-learning model is trained on training images, a portion of each training image labeled with an item depicted in the portion of the training image, the steps further comprising:
receiving, from the machine-learning model, the portion of the identified image.

13. The non-transitory computer-readable storage medium of claim 12, wherein each image is further labeled with a rating of the image input by a user of the corresponding shopping cart via the device, the steps further comprising:
causing the device to display one or more interactive elements configured to receive a rating of the image from the user.

14. The non-transitory computer-readable storage medium of claim 13, the steps further comprising:
training the machine-learning model on the image labeled with the rating from the user.

15. The non-transitory computer-readable storage medium of claim 11, wherein identifying a location of the target item within the environment comprises:
inputting an identifier of the target item and the plurality of images to a machine-learning model, the machine-learning model trained on identifiers of items in the environment labeled with one or more images depicting a respective item, the images captured by cameras coupled to shopping carts in the environment;
receiving, from the machine-learning model, a subset of the plurality of images depicting the target item;
identifying a plurality of locations, wherein each of the plurality of locations is associated with one of the subset of images, each location determined based on location data captured by a respective camera coupled to a respective shopping cart that captured the respective image; and
identifying the location of the target item based on an aggregation of the plurality of locations.

16. A system comprising:
a processor; and
a non-transitory computer-readable storage medium storing instructions that, when executed, cause the processor to perform steps comprising:
storing a plurality of images depicting items within an environment, each image captured by a camera coupled to a shopping cart in the environment and associated with location data captured by a location sensor of the corresponding shopping cart, wherein each image was captured less than a threshold amount of time from a current time;
identifying a target item associated with a user device, wherein the user device is located within the environment;
identifying a location of the target item within the environment based on item data associated with the target item and environment map data describing the environment;
selecting, from the plurality of images, an image depicting the item at the location within the environment based on the environment map data and the location data associated with each of the plurality of images;
identifying a portion of the identified image that depicts the target item by applying a machine-learning model to the identified image, wherein the machine-learning model is trained to identify portions of images that depict items;
modifying the identified portion of the identified image to highlight the target item; and
transmitting the image to the user device for display.

17. The system of claim 16, wherein the machine-learning model is trained on training images, a portion of each training image labeled with an item depicted in the portion of the training image, the steps further comprising:
receiving, from the machine-learning model, the portion of the identified image.

18. The system of claim 17, wherein each image is further labeled with a rating of the image input by a user of the corresponding shopping cart via the device, the steps further comprising:
causing the device to display one or more interactive elements configured to receive a rating of the image from the user.

19. The system of claim 18, the steps further comprising:
training the machine-learning model on the image labeled with the rating from the user.

20. The system of claim 16, wherein identifying a location of the target item within the environment comprises:
inputting an identifier of the target item and the plurality of images to a machine-learning model, the machine-learning model trained on identifiers of items in the environment labeled with one or more images depicting a respective item, the images captured by cameras coupled to shopping carts in the environment;
receiving, from the machine-learning model, a subset of the plurality of images depicting the target item;
identifying a plurality of locations, wherein each of the plurality of locations is associated with one of the subset of images, each location determined based on location data captured by a respective camera coupled to a respective shopping cart that captured the respective image; and
identifying the location of the target item based on an aggregation of the plurality of locations.
